(19) United States
(12) Patent Application Publication
(10) Pub. No.: US 2008/0187479 A1
(43) Pub. Date: Aug. 7, 2008

(54) Method of Producing Ultra-Hard Abrasive Particles

(76) Inventor: Mark Gregory Munday, County Clare (IE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/913,611

(22) PCT Filed: May 4, 2006
(86) PCT No.: PCT/IB2006/001151

§ 371 Date: Mar. 20, 2008

(30) Foreign Application Priority Data
May 4, 2005 (ZA) 2005/03546

(51) Int. Cl. C01B 21/064; C01B 31/06

(52) U.S. Cl. 423/290; 423/446

(57) ABSTRACT

The invention relates to a method for debindering and/or purifying granules or material suitable for use in High Pressure High Temperatures diamond or cubic boron nitride synthesis, the method comprising the steps of passing the granules or material through a zone having controlled atmosphere and temperature in a continuous manner, the zone having a maximum temperature within the zone of greater than approximately 600° C, wherein the time spent by each granule within the zone is less than 30 minutes.

### BACKGROUND OF THE INVENTION

This invention relates to a method of producing ultra-hard abrasive particles, particularly diamond particles.

Methods of producing diamond and cubic boron nitride abrasive particles synthetically are well known in the art. The methods can be tailored to produce particles having particular characteristics. For example, the method may be tailored to produce friable diamond particles, which are used in applications such as grinding. Alternatively, the method may be tailored to produce a strong blocky diamond of good quality. Such diamonds are typically used in saws and grinding applications.

Diamonds are synthesised by subjecting a carbon source i.e. a precursor of diamond, to elevated temperature and pressure conditions at which diamond is crystallographically stable, generally in the presence of a diamond solvent catalyst. Similarly, cubic boron nitride particles are synthesised by subjecting hexagonal boron nitride, i.e. the precursor of cubic boron nitride, to elevated temperature and pressure conditions at which cubic boron nitride is crystallographically stable in the presence of a solvent/catalyst for cubic boron nitride. EP 0 737 510 describes a method of synthesising diamond particles by coating fine diamond particles with at least one layer of a non-diamond carbon material, a catalyst/solvent in the form of a metal powder and an organic binder, compacting the coated particles in such a manner that they are at least partially in contact with each other, placing the compacted arrangement in a suitable synthesising vessel and subjecting the compacted arrangement to temperature and pressure conditions at which diamond is crystallographically stable.

There are certain advantages to using coated fine diamond particles to form granules for synthesising larger diamonds. Such granules may be compacted so as to yield a compact in which the fine diamond seeds are arranged in a regular array, or at least separated by a certain minimum distance from each other. Using such a compact to synthesise diamond has the potential to yield a greater quantity of high quality diamond than would be the case if the seed diamonds were randomly distributed throughout the compact.

However, the binder material needs to be removed from the granules prior to their compaction to form a solid compact used in the diamond synthesis process. This is typically achieved by subjecting the granules to elevated temperatures within a selected atmosphere and pressure, within a furnace. The temperature required depends on the binder material used. Temperatures in the range 300-600° C. are taught by EP 0 737 510, which also teaches that the furnace atmosphere should be reducing or inert in order to minimize oxidation of the solvent metal within the compact. Examples disclosed are of a stream of hydrogen gas or hydrogen/nitrogen gas mixtures passed over the granules for periods of between thirty and sixty minutes, at temperatures of between 400 and 600° C. This is a batch process whereby the granules are packed within a furnace and remain static while a heated atmosphere of the selected gas is passed over them and the gaseous by-products of the binder removal process are pumped out of the furnace.

A potential disadvantage of the binder removal process disclosed in EP 0 737 510 is that the granules are significantly weakened by the removal of the binder, the purpose of which is to bind together the constituents. This is likely to increase the probability of granules breaking up during the subsequent handling and transportation prior to their compaction, with the consequence that the beneficial effect of granulation resulting in superior diamond quality is reduced. Another disadvantage of limiting the temperature to less than 600° C. is that the time spent at the elevated temperature needs to be relatively long in order to effect the complete binder removal, since the removal rate tends to increase with an increase in temperature. This has the deleterious effect of tending to increase the extent of solvent metal oxidation, which increases with increased time at elevated temperature as well as with the temperature itself.

A further disadvantage of the batch furnacing approach to binder removal is the potential for differential binder removal rates and hence actual binder removal for granules in different parts of the furnace, since temperature gradients typically exist within batch furnaces. This problem is exacerbated if the granules are packed on top of one another in relatively thick layers, since the granules in different positions within this configuration are likely to experience different temperatures, heating rates as well as binder burn-off rates and rates of gaseous by-product removal rates. Consequently, either some granules will still contain some binder material after the removal process or the process time needs to be longer than necessary, with the consequence of greater than necessary oxidation of the solvent metals. Incomplete binder removal at this stage is known to have a deleterious effect on the quality and yield of diamond grown during the subsequent synthesis process.

### SUMMARY OF THE INVENTION

According to the present invention, a method of removing binder material from a plurality of granules, each comprising at least one abrasive particle, a precursor for the abrasive particle, a solvent/catalyst for the abrasive particle or precursor of such a solvent/catalyst, and binder material, comprises passing the granules continuously through a heated zone at a temperature and for a time sufficient to remove the binder material from substantially all of the granules.

### DESCRIPTION OF THE EMBODIMENTS

This invention is a method for removing the organic binder material used to make diamond seed coated granules used for diamond synthesis. In particular the invention relates to a method for debindering and/or purifying granules or material suitable for use in High Pressure High Temperatures diamond or cubic boron nitride synthesis (hereinafter granules), the method comprising the step of passing the granules through a zone having controlled atmosphere and temperature in a continuous manner, the zone having a maximum temperature within the zone of greater than approximately 600° C., wherein the time spent by each granule within the zone is less than 30 minutes.

Preferably the granules are packed in layers, preferably shallow layers, on a conveyor belt system and passed through a zone with controlled atmosphere and temperature in a continuous rather than batch mode, with a maximum temperature within the zone of greater than approximately 600° C. (a hot zone), where the time spent by each granule within the hot zone is less than 30 minutes. A stream of hydrogen-containing gas, typically comprising another gas such as nitrogen, and/or an inert gas, is passed continuously through the hot zone and over the moving granules, carrying away the gaseous by-products of the removal process.

The term shallow layers is intended to encompass a layer of granules less than 20 mm deep, more preferably less than 10 mm deep, more preferably less than 9 mm deep, more preferably less than 8 mm deep, more preferably less than 7 mm deep, more preferably less than 6 mm deep, most preferably less than 5 mm deep.

Preferably the hot zone has a temperature of greater than 700° C., more preferably greater than 750° C., more preferably greater than 800° C., more preferably greater than 850° C., most preferably greater than 900° C. Preferably the minimum temperature is the pyrolysis temperature of the binder included in the granules.

Preferably the hot zone has a temperature of less than 1300° C., more preferably less than 1190° C., more preferably less than 1180° C., more preferably less than 1170° C., more preferably less than 1160° C., most preferably less than 1150° C.

Preferably the time spent by each granule within the hot zone is less than 10 minutes, more preferably less than 9 minutes, more preferably less than 8 minutes, more preferably less than 7 minutes, more preferably less than 6 minutes, most preferably less than 5 minutes.

The rate of passage of the granules through the hot zone, the rate of flow of the stream of gas in the hot zone and hence the removal of the gaseous by-products, as well as the temperature and the dimensions of the hot zone can be well controlled using this method. Consequently, the binder removal process can be very well controlled, as can the homogeneity of the binder removal in the granules.

Preferably there is a net difference in the velocity of the stream of gas passed through the hot zone and the velocity of passage of the granules. It will be appreciated that the gas stream and granules may travel in the same direction (at different velocities) but in a preferred embodiment of the present invention, the stream of gas is counter to a direction of passage of the granules.

It is an important feature of the method of this invention that it is so arranged that each granule experiences substantially the same conditions of temperature and gaseous environment. A consequence of this is that the binder removal reactions, removal of the reaction products and any change brought about to the granules by the method is substantially identical for each granule. This in turn has desirable consequences of reproducibility and for optimization of the chemical and physical state of each granule as it pertains to the use of a compact of the granules to make superior quality synthetic diamond.

An advantage of this invention is that all granules are equally treated within the binder removal process in that they are all exposed to equivalent conditions of temperature and atmosphere over the same period of time. Hence all granules experience the same rate and degree of binder removal. Consequently, once the furnacing conditions have been optimized, all granules have the potential to yield the same superior quality diamond crystals. Furthermore, since the time period of exposure to elevated temperature is lower than in the prior art, as a consequence of the higher temperatures used here, there is the potential for reduced oxidation of the solvent metal within the granules.

Another advantage of using temperatures higher than 600° C. is that the degree of bonding between the solvent metal powders within the granules is greater, since the degree of such bonding tends to increase with increased temperature. Consequently, the granules tend to be stronger after the binder removal process and are therefore more robust and the degree of granule breakage during handling and transportation is reduced. The fact that the granules are more likely to retain their structural integrity up to and during the compaction process means that the benefit of using compacted granules for diamond synthesis is more likely to be fully realized.

The extent of the benefit of this method as opposed to a batch furnacing process on the quality of the diamond subsequently produced using the granules is surprisingly great.

The granules that are treated in accordance with the method of the invention each contain an ultra-hard abrasive particle and preferably only one such particle. The granules also contain solvent/catalyst for the ultra-hard abrasive particles or a precursor of such a solvent/catalyst and a precursor for the ultra-hard abrasive particles. The granules will be a coherent mass of the various components in any suitable shape or size and may be produced by methods such as granulation, pelletising or spray coating.

The granules also contain a binder, which may be an organic or inorganic binder, preferably an organic binder. Examples of such binders are cellulose ethers, organic polymers and the like. Such binders are removed in accordance with the method of the invention prior to subjecting the granules to the high temperature/high pressure growth conditions.

The abrasive particles will generally be diamond or cubic boron nitride particles. The method has particular application in the production of diamond particles. The particles in the granules will generally be fine, e.g. have a size of less than 100 microns.

The solvent/catalyst or precursor thereof and the precursor for the abrasive particle may be provided in layer form or as a mixture in each granule, the latter being preferred. These components will generally be in powder form in the granules.

Solvent/catalysts for diamond and cubic boron nitride are well known in the art. Particularly suitable examples for diamond solvent/catalysts are transition metals such as cobalt, iron, nickel or alloys containing one or more of these metals. A precursor of the solvent/catalyst may also be used. Examples of diamond solvent/catalyst precursors are oxides such as nickel oxide, cobalt oxide or iron oxide or compounds, which reduce, or pyrolise to an oxide such as carbonates and oxalates of metals such as iron, cobalt or nickel. When precursors are used, it is preferred that the granules are subjected to a heat treatment to reduce the precursors to the metal prior to subjecting the granules to the high temperature/high pressure sintering. The heat treatment for the reduction will vary according to the nature of the granules, its content and the nature of the precursor. The precursors of the solvent/catalyst reduce to the metal in a particularly fine particle size such that a finely divided and homogeneous mixture of the components of the layer around the ultra-hard abrasive particle is provided.

The precursor for diamond will be a non-diamond carbon such as graphite or amorphous carbon. The precursor for cubic boron nitride will be hexagonal boron nitride.

The elevated temperature and pressure growth conditions to which the granules are subjected are well known in the art. Typical pressures are in the range of 3 to 8 GPa and typically temperatures are in the range of 1000 to 2100° C.

The treated material is removed from the reaction zone of the high temperature/high pressure apparatus. The material is recovered using recovery steps that are known in the art.

The invention will now be described with reference to the following non-limiting examples.

### EXAMPLE 1

Granules comprising graphite, iron and nickel powders, suitable for synthesis of diamond, were heat treated on stainless steel trays passed through a conveyor furnace with a controlled, reducing atmosphere to remove the binder and purify the granules. The conditions used were that 1 kg of granules per tray (the trays have an area of 800cm²), a controlled atmosphere comprising 85% N₂, 15% H₂ with actual flow rates of 600 l/120 l per minute respectively (sufficient to avoid ingress of air at the furnace entrance and exit) was maintained, the top temperature of the furnace was 1050° C. and the time of the granules at top temperature was 4 minutes 30 seconds.

### Analysis of the Granules Following Heat-Treatment

All measurements in percent.

| Element | Batch A (1.1 mm granules) | Batch Stage B (1.6 mm granules) |
|---|---|---|
| Al | 0.0003 | 0.0007 |
| Ca | 0.0010 | 0.0007 |
| Co | 0.0002 | 0.0001 |
| Cr | 0.0010 | 0.0010 |
| Cu | 0.0011 | 0.0010 |
| Mg | 0.0001 | 0.0001 |
| Mn | 0.0009 | 0.0006 |
| Mo | 0.0005 | 0.0005 |
| N | 0.0051 | 0.0063 |
| Na | 0.0011 | 0.0056 |
| O | 0.0090 | 0.0094 |
| P | 0.0177 | 0.0022 |
| S | 0 | 0.0004 |
| Si | 0.0056 | 0.0061 |
| V | 0.0005 | 0.0005 |

### EXAMPLE 2

As above with 100% H atmosphere. Similar analytical results were obtained.

### EXAMPLE 3

As above at 900° C. The trace element chemistry was similar, but the O concentration was found to be higher at 0.0120%.

### EXAMPLE 3

As above at 1130° C. The trace element chemistry was similar, but the O concentration was found to be lower at 0.0085%.

1. A method for debindering and/or purifying granules or material suitable for use in High Pressure High Temperatures diamond or cubic boron nitride synthesis, the method comprising the step of passing the granules or material through a zone having controlled atmosphere and temperature in a continuous manner, the zone having a maximum temperature within the zone of greater than approximately 600° C., wherein the time spent by the granules or material within the zone is less than 30 minutes.

2. A method as claimed in claim 1 wherein a stream of hydrogen-containing gas is passed continuously through the zone and over the granules or material.

3. A method as claimed in claim 2 wherein the gas stream further comprises another gas such as nitrogen and/or an inert gas.

4. A method as claimed either one of claims 2 and 3 wherein the gas stream carries away the gaseous by-products of the debindering and/or purifying process.

5. A method as claimed in any preceding claim wherein the granules or material is/are stacked in shallow layers in a tray which is passed through the zone.

6. A method as claimed in any preceding claim wherein the zone has a temperature of greater than 700° C.

7. A method as claimed in any preceding claim wherein the zone has a temperature of less than 1300° C.

8. A method as claimed in any preceding claim wherein the time spent by each granule within the hot zone is less than 30 minutes

9. A method as claimed in any preceding claim wherein the rate of passage of the granules or material through the zone, the rate of flow of the stream of gas in the zone, the removal of the gaseous by-products, the temperature and the dimensions of the zone are controllable.

10. A method as claimed in any preceding claim wherein there is a net difference in the velocity of the stream of gas passed through the zone and the velocity of passage of the granules or material through the zone.

11. A method as claimed in claim 10 wherein the stream of gas is counter to a direction of passage of the granules.

12. A method as claimed in any preceding claim wherein each granule experiences substantially the same conditions of temperature and gaseous environment.

13. A method as claimed in any preceding claim wherein the temperature of the zone is such that partial sintering of the granules or material occurs.

14. A granule subjected to a method in accordance with any one of claims 1 to 13.

15. A method according to the invention, substantially as hereinbefore described or exemplified.

16. A granule according to the invention, substantially as hereinbefore described or exemplified.
